(19) United States
(12) Patent Application Publication
(10) Pub. No.: US 2016/0319888 A1
(43) Pub. Date: Nov. 3, 2016

(54) PNEUMATIC ADJUSTABLE TORQUE LIMITER

(71) Applicant: Terog Manufacturing Company, Stephen, MN (US)

(72) Inventors: Joe Thomas Rogus, Strandquist, MN (US); Jim Thomas Rogus, Strandquist, MN (US)

(73) Assignee: TEROG MANUFACTURING COMPANY, Stephen, MN (US)

(21) Appl. No.: 14/700,619

(22) Filed: Apr. 30, 2015

(51) Int. Cl. F16D 7/02; F16D 25/0635

(52) U.S. Cl. CPC F16D 7/025; F16D 25/0635

(57) ABSTRACT

A torque limiter assembly includes a drive disc, a driven disc, a pressure plate, an offset plate, a bladder, a first clutch lining, and a second clutch lining. At least a portion of the bladder contacts the offset plate. The pressure plate is separated from the offset plate via a plurality of offset members and the first clutch lining is disposed between the drive disc and the driven disc. The second clutch lining is disposed between the drive disc and the pressure plate. The bladder is pressurized to set a threshold torque at which the clutch of the assembly begins to slip. The assembly further includes a central hub. The central hub has bolts which extend radially therefrom and which secure the central hub to a shaft. The bolts are positioned between the pressure plate and the offset plate.

### CROSS-REFERENCE TO RELATED APPLICATIONS

None

### STATEMENT REGARDING FEDERALLY SPONSORED RESEARCH

Not Applicable

### BACKGROUND

Torque limiters or slip clutches are used in a variety of industrial applications in order to transmit rotational motion. Many torque limiters will begin to slip once a torque threshold has been reached and the torque applied to the clutch cannot be transferred through the clutch. Known torque limiters may suffer from a variety of shortfalls. In particular, it can be difficult to adjust the torque at which the clutch begins to slip in known torque limiters. For example, springs may need replacing or adjusting and existing designs with springs also require testing to verify torque limitations. Adjustment is also required periodically as the clutch linings wear. Therefore, there remains a need for a torque limiter that overcomes deficiencies of existing designs.

Without limiting the scope of the invention a brief summary of some of the claimed embodiments of the invention is set forth below. Additional details of the summarized embodiments of the invention and/or additional embodiments of the invention may be found in the Detailed Description, below.

A brief abstract of the technical disclosure in the specification is provided as well only for the purposes of complying with 37 C.F.R. 1.72. The abstract is not intended to be used for interpreting the scope of the claims.

### BRIEF SUMMARY

A torque limiter assembly includes a drive disc, a driven disc, a pressure plate, an offset plate, a bladder, a first clutch lining, and a second clutch lining. At least a portion of the bladder contacts the offset plate; the offset plate at least partially retains the bladder. The pressure plate is separated from the offset plate via a plurality of offset members and the first clutch lining is disposed between the drive disc and the driven disc. The second clutch lining is disposed between the drive disc and the pressure plate.

### BRIEF DESCRIPTION OF THE SEVERAL VIEWS OF THE DRAWING(S)

FIG. 1 shows a 3-dimensional view of an example of a torque limiter.

FIG. 2 shows a front view of the torque limiter of FIG. 1.

FIG. 3 shows a cross-sectional view of the torque limiter of FIGS. 1 and 2.

FIGS. 4 and 5 show exploded views of the torque limiter of FIG. 1.

FIG. 6 shows a 3-dimensional view of the torque limiter of FIG. 1, having the end plate 18 and retention member 24 removed.

FIG. 7 shows a 3-dimensional view of an example of a torque limiter for use in an inline application.

### DETAILED DESCRIPTION

In an effort to overcome deficiencies of known torque limiter designs, a torque limiter utilizes a bladder which can be inflated to a desired pressure. In turn, the torque limiter can be set to slip at a desired threshold torque. Further, when the pressure in the bladder is increased, the applied torque at which the torque limiter begins to slip is also increased.

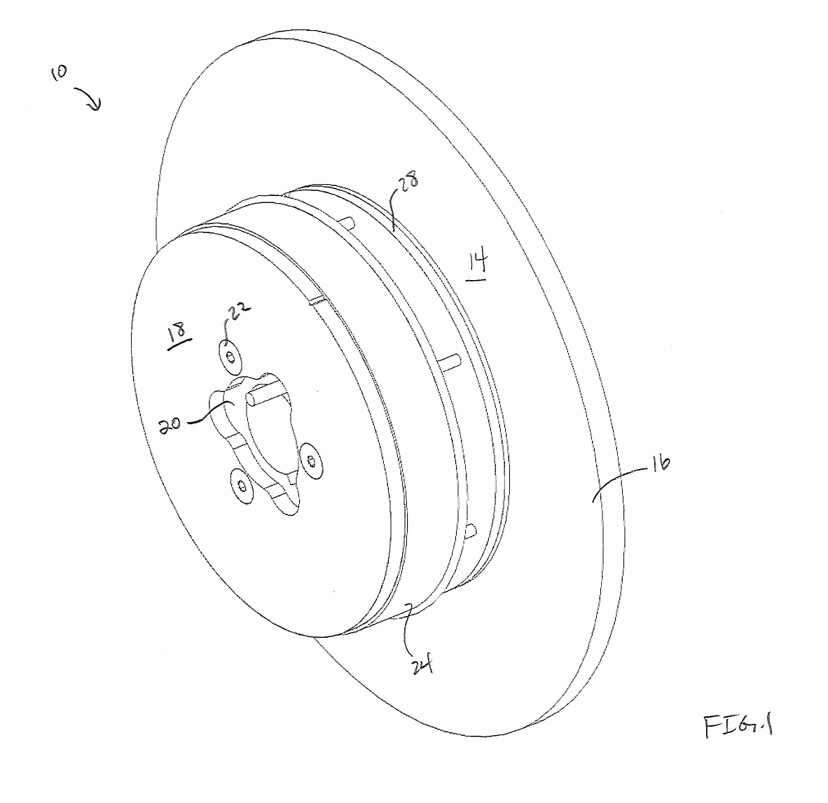

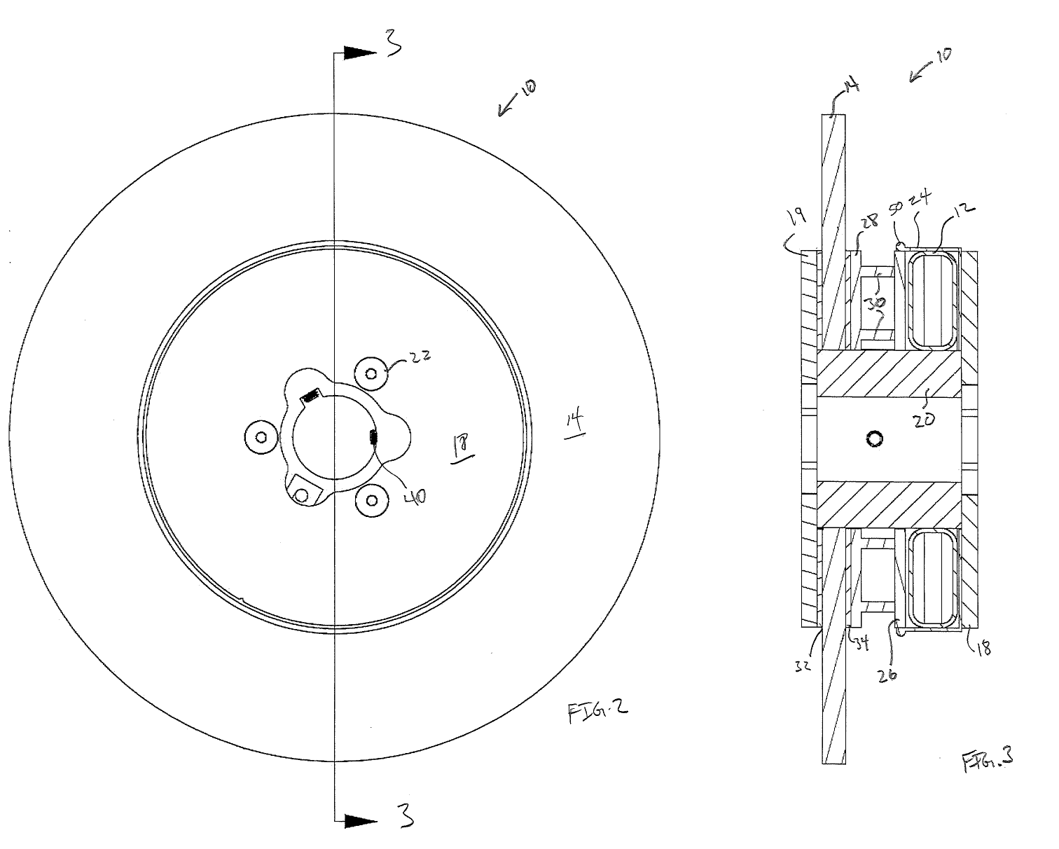

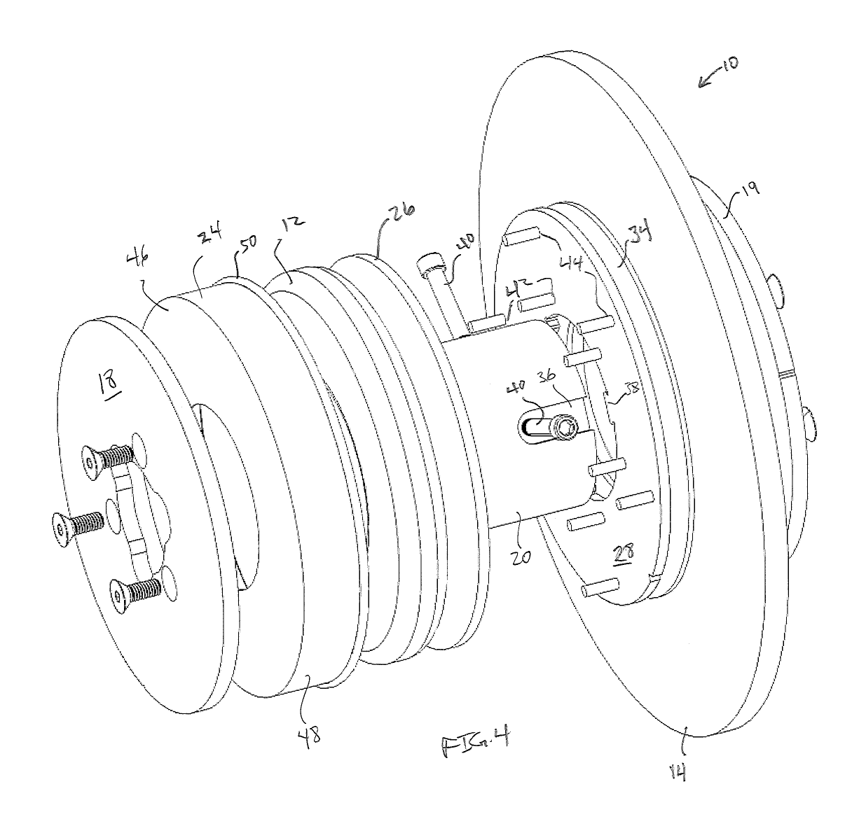

An example of a torque limiter 10 is shown in FIGS. 1-3. As illustrated via the cross-sectional view of FIG. 3, the torque limiter 10, or slip clutch 10, includes a bladder 12. The bladder 12 is pressurized to bias the clutch and prevent slipping until a predetermined amount of torque is applied to it.

Returning to FIG. 1, in some embodiments, the torque limiter 10 comprises a drive disc 14. In some embodiments, the drive disc 14 comprises a sprocket 16, which is, in turn, driven by a chain (not shown). The drive disc 14 can also be rotated via a belt, gear, direct drive, or in any other suitable way. The torque limiter 10 further comprises an end plate 18 and a central hub 20. In some embodiments, the end plate 18 is bolted to the central hub 20, for example via bolts 22. As shown in FIG. 1, for example, the end plate 18 has countersunk holes so that the bolts 22 are flush with the surface of the end plate 18.

In some embodiments, the torque limiter 10 comprises a retention member 24. In some embodiments, the torque limiter 10 further comprises an offset plate 26 and a pressure plate 28. The retention member 24 is configured to retain the bladder 12 such that the bladder 12 is confined in the radial direction. Thus, the bladder 12 can bias the offset plate 26 and pressure plate 28 toward the drive disc 14 without unnecessarily expanding in a radial direction. In at least some embodiments, the offset plate 26 contacts a side of the bladder 12.

In some embodiments, the torque limiter 10 further comprises a plurality of standoff members 30 which separate the offset plate 26 and pressure plate 28. In some embodiments, the standoff members 30 comprise lengths of cylindrical material, such as dowel pins, which are press-fit into drilled holes in the pressure plate 28. In some embodiments, the standoff members 30 comprise lengths of tubular material through which a bolt (not shown) is inserted, in order to attach the pressure plate 28 to the offset plate 26.

With further regard to FIG. 3, in some embodiments, the torque limiter 10 has a first clutch lining 32. The first clutch lining 32 is disposed between the drive disc 14 and a driven disc 19. The torque limiter 10 also has a second clutch lining 34, which is disposed between the drive disc 14 and the pressure plate 28. The clutch linings 32, 34 comprise a frictional material that resists slippage. In some embodiments, the drive disc 14 slips relative to the clutch linings 32, 34 once a threshold torque is reached. Alternatively, the pressure plate 28 and/or driven disc 19 can slip relative to the respective clutch linings 32, 34 once a threshold torque is reached. The threshold torque at which the clutch begins to slip is proportional to the amount of pressure exerted on the clutch lining 32, 34 via the bladder 12.

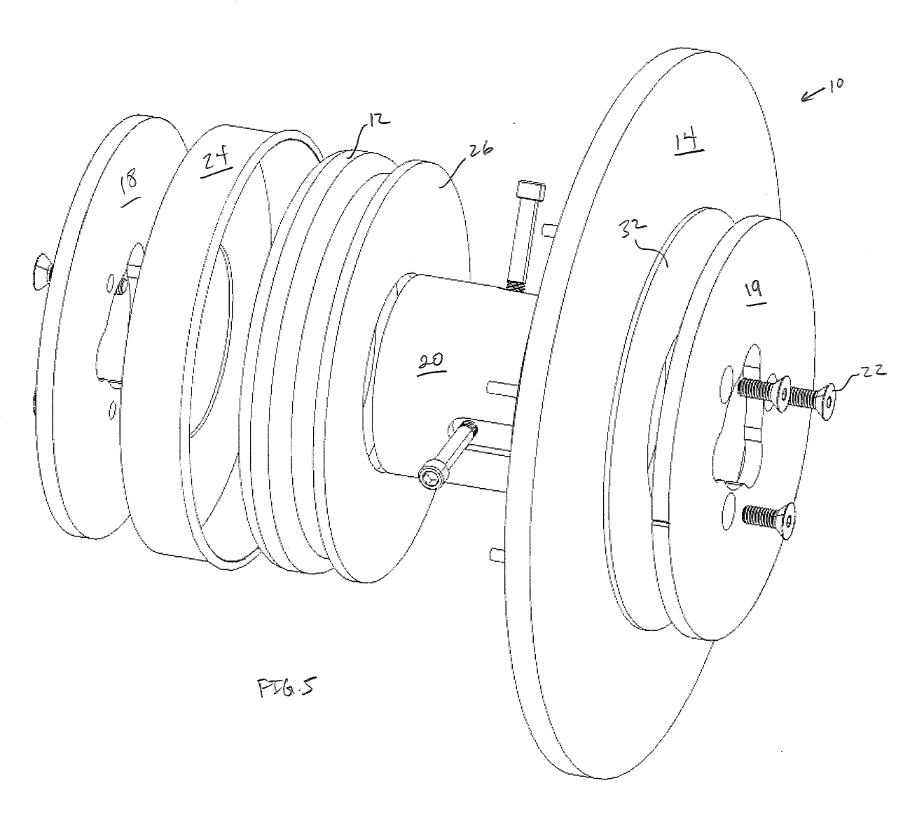

Turning to FIG. 4, an embodiment of the torque limiter 10 is shown in exploded view. As shown in FIG. 4, in some embodiments, the central hub 20 has one or more notched portions 36. The notched portions 36 correspond with mating protruding portions 38 in the pressure plate 28, in order to transfer torque between the central hub 20 and the pressure plate 28. In some embodiments, the central hub 20 has three notched portions 36 and the pressure plate 28 has three protruding portions 38, though any suitable number of notched portions 36 and protruding portions 38 can be utilized. Moreover, the central hub 20 can have protruding portions 38 and the pressure plate can have the notched portions 36. In some embodiments, the protruding portions 38 are arranged equidistantly around the pressure plate 28; for example, where the pressure plate has three protruding portions 38, they are spaced 120° apart. The arrangement of the notched portions 36 can have a similar arrangement. Other arrangements for transferring torque between the central hub 20 and the pressure plate 28 can also be employed, for example splines, fasteners, split-taper, such as a Browning taper/Browning hub, or combinations thereof, etc.

In some embodiments, the torque limiter 10 includes one or more retaining bolts 40. The retaining bolts 40 retain the shaft (not shown) within the central hub 20. The retaining bolts 40 extend radially from the central hub 20 and, in some embodiments, are located between the offset plate 26 and the pressure plate 28. In some embodiments, the torque limiter 10 includes two or three retaining bolts 40. The retaining bolts 40 are further positioned between the standoff members 30.

As further shown in FIG. 4, in some embodiments, the standoff members 30 are arranged in an inner ring 42 and an outer ring 44. The outer ring 44 of standoff members 30 are nearer to the outer periphery of the pressure plate 28; the inner ring 42 of standoff members 30 are nearer to central axis of the pressure plate 28. In some embodiments, the torque limiter 10 has between three and 20 standoff members. In some embodiments, the torque limiter 10 has twelve standoff members.

In some embodiments, the retention member 24 comprises a side portion 46 and a ring portion 48. The side portion 46 extends radially around the central hub 20. The ring portion 48 extends longitudinally from the side portion 46 over the outer periphery of the bladder 12. In this way, the ring portion 48 prevents the bladder 12 from extending radially beyond the ring portion 48 so that the bladder 12 acts to bias the pressure plate 28 (e.g., via offset plate 26) against the second clutch lining 34. In some embodiments, the retention member 24 comprises a rolled or raised edge 50. In some embodiments, a portion of the ring portion 48 further extends over at least a portion of the offset plate 26, as shown in FIG. 3, for example.

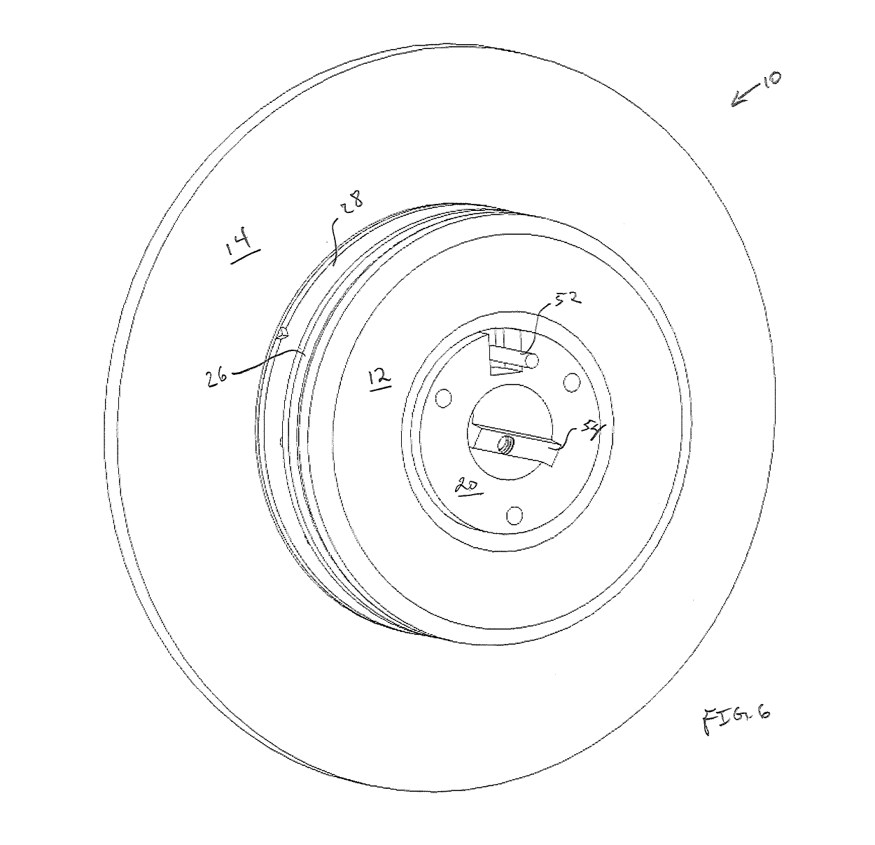

With regard to FIGS. 1 and 6, in some embodiments, the torque limiter 10 includes a valve stem 52. FIG. 6 shows the torque limiter 10 with the end plate 18 and retention member 24 removed so as to illustrate the valve stem 52. The valve stem 52 includes a valve (not shown) such as a Schrader valve or a Presta valve. The valve stem 52 is attached to the bladder 12 so that the bladder 12 can be filled with a gas, such as air. In some embodiments, the bladder 12 is filled with nitrogen gas. Other fluids can also be used to pressurize the bladder, including liquids, gasses, and combinations of liquids and gasses.

As additionally shown in FIG. 6, in some embodiments, the central hub 20 has a keyway 54. The keyway 54 can be used with a central shaft (not shown) in order to rotationally couple the central hub 20 and the central shaft. The central hub 20 can also be splined (e.g., to interface with a splined shaft), fasteners, split-taper, such as a Browning taper/Browning hub, or combinations thereof, etc. Other arrangements for transferring torque may also be employed.

Turning to FIG. 5, an embodiment of the torque limiter 10 is shown in an exploded view. In some embodiments, the driven disc 19 is attached to the central hub 20 via bolts 22. In some embodiments, the driven disc 19 is a mirror image of the end plate 18. In some embodiments, the driven disc 19 and the end plate 18 are the same.

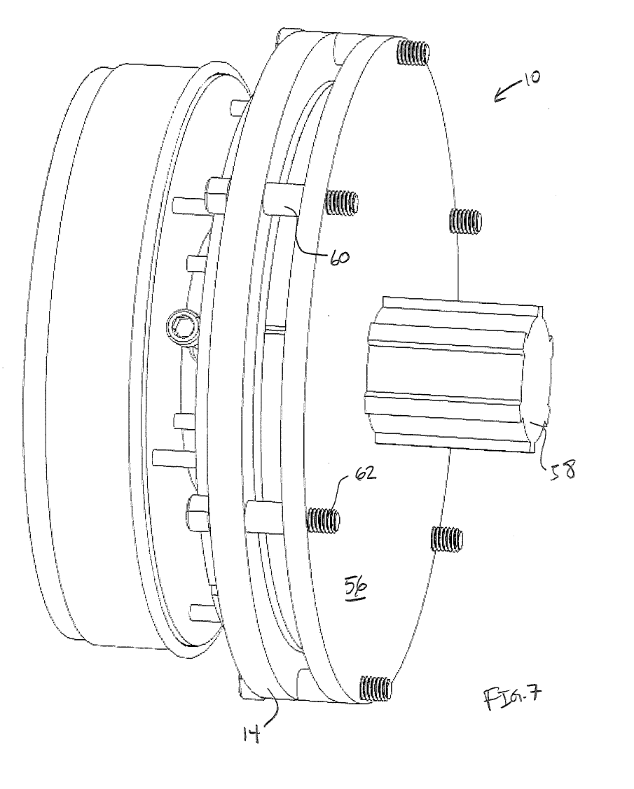

With regard to FIG. 7, in some embodiments, the torque limiter 10 is employed in an inline application. As shown, by way of example, the drive disc 14 of the torque limiter 10 is bolted to a torque plate 56. Attached to the torque plate 56 is an input shaft 58. In some embodiments, the torque plate 56 is offset from the drive disc 14 via spacers 60. Further, in some embodiments, the torque plate 56 has threaded holes into which torque plate bolts 62 are secured. Nuts (not shown) can be used instead of threading torque plate bolts 62 directly into the torque plate.

The input shaft 58 can be splined or keyed, for example, in order to transfer torque. Other configurations are also permissible. Further, although certain terms like “drive” or “driven” (e.g., drive disc 14, driven disc 19) are used herein, it will be appreciated that the torque limiter 10 can be reversed such that the drive input/plate/disc is, in practice, the driven input/plate/disc and vice-versa.

As shown in Table 1, below, the threshold torque at which the torque limiter 10 begins to slip is associated with a pressure within the bladder 12. Increasing the pressure within the bladder 12 provides a higher threshold torque at which the torque limiter 10 begins to slip. As shown in Table 1, the inflation pressure of the bladder is measured in PSI (pounds per square inch, while the threshold torque is measured in foot-pounds).

TABLE 1

| Pressure (PSI) | Torque (ft.-lbs.) |
|---|---|
| 10 | 100 |
| 20 | 700 |
| 40 | 1100 |
| 60 | 1550 |
| 80 | 1850 |
| 100 | 2350 |
| 120 | 2500 |

In some embodiments, the standoff members 30 permit an air gap between the pressure plate 28 and the offset plate 26. The standoff members 30, and associated air gap, dissipate heat generated when the torque limiter 10 slips. Thus, heat transfer to the bladder 12 and offset plate 26, in the event the torque limiter 10 slips, is reduced. Consequently, the bladder 12 can be made from a material that does not need to be highly heat tolerant. For example, the bladder 12 can be formed from a rubber material. Other materials can also be utilized. Further, a fluid that readily absorbs heat (e.g., has a high heat capacity) can be used in the bladder 12 in order to further prevent damage from heat due to slippage of the torque limiter 10.

In some embodiments, the torque limiter 10, having bladder 12, can include a plurality of balls that are selectively located in detents, for example, in lieu of clutch linings 32, 34. An example of a torque-limiting overload coupling utilizing ball bearings and seats is shown in U.S. Pat. No. 4,174,621 to Woltjen, which is herein incorporated by reference.

A description of some embodiments of the stents and the delivery catheter are contained in one or more of the following numbered statements:
Statement 1. A torque limiter assembly comprising:

a drive disc;

a driven disc;

a pressure plate;

an offset plate;

a first clutch lining and a second clutch lining; and

a bladder, at least a portion of the bladder contacting the offset plate, wherein the pressure plate is separated from the offset plate via a plurality of offset members, the first clutch lining being disposed between the drive disc and the driven disc, and the second clutch lining being disposed between the drive disc and the pressure plate.
Statement 2. The torque limiter assembly of statement 1, wherein the drive disc comprises a sprocket.
Statement 3. The torque limiter assembly of statement 1 further comprising a retention member, the retention member surrounding the bladder.
Statement 4. The torque limiter assembly of statement 1 further comprising a central hub, the driven disc being rigidly attached to the central hub.
Statement 5. The torque limiter assembly of statement 4, wherein the central hub has a keyway, spline, split-taper, or combination thereof
Statement 6. The torque limiter assembly of statement 1 further comprising an end plate, wherein the bladder is disposed between the end plate and the offset plate.
Statement 7. The torque limiter assembly of statement 6, further comprising a central hub, the end plate being rigidly attached to the central hub.
Statement 8. The torque limiter assembly of statement 1 further comprising a valve in fluid communication with the bladder.
Statement 9. The torque limiter assembly of statement 8, wherein the valve is a Schrader valve or Presta valve.
Statement 10. The torque limiter assembly of statement 1, wherein the bladder has a toroidal shape.
Statement 11. The torque limiter assembly of statement 1, wherein the bladder is filled with a gas.
Statement 12. The torque limiter assembly of statement 11, wherein the gas consists essentially of nitrogen.
Statement 13. The torque limiter assembly of statement 1, wherein the bladder is at least partially filled with a liquid.
Statement 14. A torque limiter assembly comprising:

a drive disc;

a driven disc;

a pressure plate;

a first clutch lining and a second clutch lining; and

a bladder, the first clutch lining being disposed between the drive disc and the driven disc and the second clutch lining being disposed between the drive disc and the pressure plate.
Statement 15. The torque limiter assembly of statement 14, wherein the driven disc is rigidly attached to an input shaft.
Statement 16. The torque limiter assembly of statement 14, wherein the bladder biases the pressure plate against the drive disc and the second clutch lining.
Statement 17. The torque limiter assembly of statement 16, wherein the bladder further biases the drive disc against the driven disc and the first clutch lining.
Statement 18. A torque limiter assembly comprising:

a central hub;

an annular-shaped inflatable bladder, the central hub extending through the center of the annular-shaped inflatable bladder;

a retention member disposed around to the inflatable bladder;

a drive disc;

a driven disc; and

a clutch member; wherein the inflatable bladder biases the drive disc against the driven disc and the clutch member is disposed between the drive disc and the driven disc.
Statement 19. The torque limiter assembly of statement 18, wherein the clutch member comprises a clutch lining.
Statement 20. The torque limiter assembly of statement 19 further comprising a pressure plate, wherein the inflatable bladder biases the pressure plate against the drive disc and a second clutch lining is disposed between the pressure plate and the drive disc.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A torque limiter assembly comprising:
a drive disc;
a driven disc;
a pressure plate;
an offset plate;
a first clutch lining and a second clutch lining; and
a bladder, at least a portion of the bladder contacting the offset plate, wherein the pressure plate is separated from the offset plate via a plurality of offset members, the first clutch lining being disposed between the drive disc and the driven disc, and the second clutch lining being disposed between the drive disc and the pressure plate.

2. The torque limiter assembly of claim 1, wherein the drive disc comprises a sprocket.

3. The torque limiter assembly of claim 1 further comprising a retention member, the retention member surrounding the bladder. 20

4. The torque limiter assembly of claim 1 further comprising a central hub, the driven disc being rigidly attached to the central hub.

5. The torque limiter assembly of claim 4, wherein the central hub has a keyway, spline, split-taper, or combination thereof.

6. The torque limiter assembly of claim 1 further comprising an end plate, wherein the bladder is disposed between the end plate and the offset plate.

7. The torque limiter assembly of claim 6, further comprising a central hub, the end plate being rigidly attached to the central hub.

8. The torque limiter assembly of claim 1 further comprising a valve in fluid communication with the bladder.

9. The torque limiter assembly of claim 8, wherein the valve is a Schrader valve or Presta valve.

10. The torque limiter assembly of claim 1, wherein the bladder has a toroidal shape.

11. The torque limiter assembly of claim 1, wherein the bladder is filled with a gas.

12. The torque limiter assembly of claim 11, wherein the gas consists essentially of nitrogen.

13. The torque limiter assembly of claim 1, wherein the bladder is at least partially filled with a liquid.

14. A torque limiter assembly comprising:
a drive disc;
a driven disc;
a pressure plate;
a first clutch lining and a second clutch lining; and
a bladder, the first clutch lining being disposed between the drive disc and the driven disc and the second clutch lining being disposed between the drive disc and the pressure plate.

15. The torque limiter assembly of claim 14, wherein the driven disc is rigidly attached to an input shaft.

16. The torque limiter assembly of claim 14, wherein the bladder biases the pressure plate against the drive disc and the second clutch lining.

17. The torque limiter assembly of claim 16, wherein the bladder further biases the drive disc against the driven disc and the first clutch lining.

18. A torque limiter assembly comprising:
a central hub;
an annular-shaped inflatable bladder, the central hub extending through the center of the annular-shaped inflatable bladder;
a retention member disposed around to the inflatable bladder;
a drive disc;
a driven disc; and
a clutch member; wherein the inflatable bladder biases the drive disc against the driven disc and the clutch member is disposed between the drive disc and the driven disc.

19. The torque limiter assembly of claim 18, wherein the clutch member comprises a clutch lining.

20. The torque limiter assembly of claim 19 further comprising a pressure plate, wherein the inflatable bladder biases the pressure plate against the drive disc and a second clutch lining is disposed between the pressure plate and the drive disc.
